(19) United States
(12) Patent Application Publication
(10) Pub. No.: US 2024/0100545 A1
(43) Pub. Date: Mar. 28, 2024

(54) METHODS AND COMPOSITIONS FOR LITHIUM ORE BENEFICIATION

(71) Applicant: Ecolab USA Inc., St. Paul, MN (US)

(72) Inventors: Ryan Travis Chester, Connolly (AU); Timothy La, Kardinya (AU)

(21) Appl. No.: 18/243,909

(22) Filed: Sep. 8, 2023

Related U.S. Application Data
(60) Provisional application No. 63/405,602, filed on Sep. 12, 2022.

(51) Int. Cl. B03D 1/008; B03D 1/02

(52) U.S. Cl. CPC B03D 1/008; B03D 1/02; B03D 2201/02; B03D 2203/02

(57) ABSTRACT

Disclosed herein are compositions and methods for lithium ore beneficiation. The methods and compositions are suitable for use in froth flotation of lithium ore sources. The methods include combining a lithium ore source, a water source, and a collector composition to form a lithium beneficiation slurry; sparging the lithium beneficiation slurry; separating the sparged lithium beneficiation slurry to form a lithium beneficiary and a gangue; and collecting the lithium beneficiary, where the collector includes a C10 to C28 hydroxycarboxylic acid, a surfactant, and a solvent. The collectors obtain high yield of lithium and excellent selectivity for lithium species in the froth flotation of lithium ores.

### BACKGROUND

Lithium metal has many industrial applications including uses in rechargeable batteries, ceramics, aluminum alloys, pharmaceuticals, polymers, specialty glass, high-temperature grease, and casting flux. One of the primary applications of high-purity lithium is lithium-ion batteries. Lithium-ion batteries have a much higher charge-to-weight ratio and power-to-weight ratio than lead/acid and zinc carbon cells, and the development of lithium-ion battery technology has caused a global increase in the demand for lithium as a battery metal. The popularity of small electronic devices employing lithium-ion batteries was an initial driver of an increased demand, while the more recent adoption of rechargeable batteries to power vehicles has caused a large increase in the demand for high-purity lithium metal.

Lithium-bearing mineral ores such as spodumene ores and lithium micas are commercially employed as sources of high-purity lithium metal. Spodumene is a pyroxene mineral having the chemical composition LiAlSi₂O₆ (with minor amounts of Na substituted for Li in some cases). Lepidolite, a lithium-rich mica (basic potassium lithium aluminum fluorosilicate), is another industrially useful source of lithium metal. Commercially, lithium-bearing ores may be subjected to one or more processes to liberate, collect, and/or purify lithium species, that is, to separate the lithium-bearing mineral—such as spodumene—from the surrounding impurities and rock matrix materials such as quartz, feldspar, and the like commonly associated with mineral ore sources. These separation processes exploit the differences in physical and chemical properties between ore components.

One process employed industrially to separate lithium species from lithium ores is froth flotation. In froth flotation, an ore is comminuted to provide an ore particulate having particles with a maximum dimension of several millimeters or less, in some cases a millimeter or less, for example particles having US mesh in accordance with ASTM-E11 of 35 or finer, or even 50 mesh or finer; and the comminuted ore is combined with water to form a slurry or pulp typically 30% solids by weight or more, for example 50 wt % ore solids or more. The slurry is sparged, sometimes with mechanical agitation, causing lithium species to preferentially adhere to bubbles within the sparged slurry. The bubbles are then allowed to separate from the slurry by flotation, forming a froth at the slurry-air interface; and the froth is collected from the surface of the slurry. The collected froth includes a concentrated amount of lithium mineral product, or beneficiary; whereas the remaining slurry product, termed the gangue, is depleted in the lithium mineral product. Often, several cycles of lithium ore sparging and collection are carried out in a flotation circuit, such as a rougher-scavenger type circuit, in order to maximize yield of the lithium beneficiary collected.

A frothing agent may be added to a lithium ore slurry to adjust the tendency of the slurry to form bubbles of desirable size and rise velocity as well as provide a stable froth (where most of the bubbles collected as a froth at the surface of the slurry do not rupture during the flotation and collection thereof). Additionally, a collector may be added to the lithium ore slurry to further increase the tendency of the lithium mineral product to associate with the surface of the bubbles. Common collectors include cationic surfactants, though nonionic surfactants and anionic surfactants have been employed. However, the industry presently suffers from a paucity of technologies for maximizing product yield, purity, and overall efficiency of the lithium ore flotation process.

Accordingly, there is an ongoing need in the industry to increase the efficiency of froth flotation of lithium ores. There is an ongoing need in the industry to increase the yield of lithium species obtained from lithium ore sources. There is a need in the industry to obtain lithium compounds, or species of increased purity from lithium ore slurries. Ideally, these needs should be addressed using apparatuses and equipment already in use in the mineral ore processing industry, in order to avoid undue complication and cost to operators wishing to obtain the benefits of increased lithium ore processing efficiency and yield.

The foregoing needs are addressed by the compositions and methods described herein.

### BRIEF DESCRIPTION OF THE DRAWINGS

FIG. 1 is a plot of grade % of lithium (as Li₂O) as a function of % Li₂O recovered in Example 2.

FIG. 2 is a plot of grade % of lithium (as Li₂O) as a function of % Li₂O recovered in Example 3.

### SUMMARY OF THE INVENTION

Disclosed herein are methods of lithium ore beneficiation and lithium beneficiation slurries. The methods comprise, consist essentially of, or consist of combining a lithium ore source, a water source, and a collector composition to form a lithium beneficiation slurry; sparging the lithium beneficiation slurry; separating the sparged lithium beneficiation slurry to form a lithium beneficiary and a gangue; and collecting the lithium beneficiary, wherein the collector composition comprises, consists essentially of, or consists of a hydroxycarboxylic acid, a surfactant, and a solvent. In embodiments, the lithium ore source comprises a spodumene ore. In embodiments, the methods further include comminuting the lithium ore source and/or classifying the lithium ore source prior to combining the lithium ore source with the water source and the collector composition. In embodiments, the sparging comprises, consists essentially of, or consists of agitating the lithium beneficiation slurry, bubbling a gas through the lithium beneficiation slurry, or contemporaneously agitating and bubbling a gas through the lithium beneficiation slurry. In embodiments the gas comprises, consists essentially of, or consists of air or CO₂. In embodiments, the lithium beneficiary is a froth.

Also disclosed herein are collector compositions. In embodiments the collector composition is used in a lithium ore beneficiation. The collector compositions comprise, consist essentially of, or consist of a hydroxycarboxylic acid, a surfactant, and a solvent. In embodiments, the hydroxycarboxylic acid comprises, consists essentially of, or consists of a C10 to C28 hydroxycarboxylic acid or a C16 to C20 hydroxycarboxylic acid. In embodiments, the hydroxycarboxylic acid includes one hydroxyl group. In embodiments, the hydroxycarboxylic acid comprises, consists essentially of, or consists of ricinoleic acid. In embodiments, the collector compositions exclude, or substantially exclude oleic acid or a conjugate base thereof.

In embodiments, the surfactant comprises, consists essentially of, or consists of an anionic surfactant, a nonionic surfactant, or combination thereof. In embodiments, the anionic surfactant comprises, consists essentially of, or consists of a dianionic surfactant, a sulfonated surfactant, or a combination thereof. In embodiments, the nonionic surfactant comprises, consists essentially of, or consists of a polyalkoxylated sorbitan fatty acid ester.

In embodiments, the solvent comprises, consists essentially of, or consists of methanol, ethanol, isopropanol, n-propanol, n-butanol, isobutanol, ethylene glycol, propylene glycol, 2-methoxyethanol (methyl cellosolve), 2-butoxyethanol (butyl cellosolve), diethylene glycol, 2-(2-methoxyethoxy)ethanol, bis(2-methoxyethyl) ether (diglyme), triethylene glycol, glycerol, ethyl acetate, acetone, methyl ethyl ketone, and triacetin. In embodiments, the solvent is an aqueous solvent comprising, consisting essentially of, or consisting of one or more of the foregoing solvents, further mixed with water or a water source. Where the solvent is an aqueous solvent, the solvent and water are mixed in a water:solvent weight ratio of between 50:1 and 1:1.

Also disclosed herein are lithium beneficiation slurries, the lithium beneficiation slurries comprising, consisting essentially of, or consisting of a lithium ore source, a water source, a collector composition comprising, consisting essentially of a hydroxycarboxylic acid, surfactant, and a solvent. In embodiments, the lithium ore source comprises, consists essentially of, or consists of a pegmatite, a Zinnwaldite, a Jadarite, a lithium mica, or another solid lithium ore that includes a compound including lithium. In embodiments, the lithium ore source comprises, consists essentially of, or consists of a comminuted lithium ore source, or a classified lithium ore source, or a comminuted, classified lithium ore source. In embodiments, the lithium ore source excludes lithium brines, that is, lithium-bearing compounds dissolved or dispersed in a liquid.

In embodiments, the hydroxycarboxylic acid comprises, consists essentially of, or consists of a C10 to C28 hydroxycarboxylic acid, or a C16 to C20 hydroxycarboxylic acid. In embodiments, the hydroxycarboxylic acid includes one hydroxyl group. In embodiments, the hydroxycarboxylic acid comprises, consists essentially of, or consists of ricinoleic acid. In embodiments, the surfactant comprises, consists essentially of, or consists of an anionic surfactant, a nonionic surfactant, or combination thereof. In embodiments, the surfactant comprises, consists essentially of, or consists of a dianionic surfactant, a sulfonated surfactant, a polyalkoxylated sorbitan fatty acid ester, or a combination thereof.

Also disclosed herein are collector compositions comprising, consisting essentially of, or consisting of a hydroxycarboxylic acid, a surfactant, and a solvent. The collector compositions are useful for adding to a lithium ore slurry to form a lithium beneficiation slurry having improved yield, purity, or both of lithium mineral product obtained in a froth flotation of the lithium beneficiation slurry, when compared to the yield, purity, or both of the lithium mineral product obtained in the absence of the collector composition. In embodiments, the hydroxycarboxylic acid comprises, consists essentially of, or consists of a C10 to C28 hydroxycarboxylic acid or a C16 to C20 hydroxycarboxylic acid or a mixture of these. In embodiments, the hydroxycarboxylic acid includes one, two or three hydroxyl groups. In embodiments, the hydroxycarboxylic acid comprises, consists essentially of, or consists of ricinoleic acid. In embodiments, the surfactant comprises, consists essentially of, or consists of an anionic surfactant, a nonionic surfactant, or combination thereof. In embodiments, the surfactant comprises, consists essentially of, or consists of a dianionic surfactant, a sulfonated surfactant, a polyalkoxylated sorbitan fatty acid ester, or a mixture thereof. In embodiments, the collector composition comprises, consists essentially of, or consists of 10 wt % to 50 wt % of the hydroxycarboxylic acid, 10 wt % to 50 wt % of the surfactant, and 3 wt % to 70 wt % of the solvent, wherein the three components together constitute 100% of the collector composition or 100% of the collector composition actives.

In embodiments, the collector composition is added to a lithium ore source in an amount corresponding to about 0.01 gram to 10 grams of the collector composition per kg of the lithium ore source; and a water source is added to the combined lithium ore source and collector composition to form a lithium beneficiation slurry. In embodiments, the collector composition is added to a lithium ore slurry in an amount corresponding to about 0.01 gram to 10 grams of the collector composition per kg of the lithium ore source to form a lithium beneficiation slurry. In embodiments, the collector composition is added to a lithium ore source or a lithium ore slurry as a mixture of the three components: the hydroxycarboxylic acid, the surfactant, and the solvent; in other embodiments, the collector composition actives (solids) are added separately to a lithium ore source or to a lithium ore slurry, contemporaneously or sequentially in any order to form a lithium beneficiation slurry, further wherein the actives comprise, consist essentially of, or consist of a hydroxycarboxylic acid and a surfactant.

Accordingly, in embodiments, the collector composition is added to a lithium ore source or a lithium ore slurry in an amount of about 10 ppm to 10,000 ppm actives based on the weight of the lithium ore source. In embodiments the collector composition is added as a mixture of a hydroxycarboxylic acid, a surfactant, and a solvent to a lithium ore source or a lithium ore slurry. In other embodiments the collector composition is added, as individual components thereof to a lithium ore source or a lithium ore slurry

In embodiments, the lithium ore beneficiation methods described herein are suitable as batch type or continuous processes. In any of the foregoing embodiments, two or more cycles of lithium ore beneficiation are suitably carried out in a flotation circuit in order to more fully deplete an ore slurry of the lithium mineral.

Thus, in embodiments, any of the lithium ore beneficiation compositions and collector compositions described herein are suitably employed in a first beneficiation process carried out in a first circuit stage; wherein second, third, fourth, or more beneficiation processes are subsequently carried out using the separated beneficiary and gangue obtained in the first stage of the circuit, for second, third, fourth, or more circuit stages. Thus, disclosed herein are methods of combining a lithium ore source, a water source, and a collector composition to form a first lithium beneficiation slurry; sparging the first lithium beneficiation slurry; separating the first sparged lithium beneficiation slurry to form a first lithium beneficiary and a first gangue; and collecting the first lithium beneficiary, wherein the collector composition comprises, consists essentially of, or consists of a hydroxycarboxylic acid, a surfactant, and a solvent; applying the first lithium beneficiary, or the first gangue, or separately applying both the first lithium beneficiary and the first gangue to a second lithium ore beneficiation process, wherein the first lithium beneficiary, or the first gangue, or both are subjected to a second beneficiation by adding additional water source and collector composition to the first lithium beneficiary or the first gangue form a second lithium beneficiation slurry; sparging the second lithium beneficiation slurry; separating the second sparged lithium beneficiation slurry to form a second lithium beneficiary and a second gangue. In embodiments, first and second lithium beneficiaries, and optionally third, fourth, etc. lithium beneficiaries are combined to form a combined lithium beneficiary. In embodiments, a combined lithium beneficiary includes two or more lithium beneficiaries resulting from combining the beneficiaries of two or more lithium ore beneficiation processes as described herein, for example as obtained from a flotation circuit. In embodiments, a combined gangue is formed by combining of the gangues of two or more lithium ore beneficiation processes, such as those obtained from a flotation circuit.

In embodiments, a lithium beneficiary collected in accordance with any of the methods described herein includes more lithium, measured as Li₂O, than a beneficiary obtained with the same beneficiation slurry in the absence of the hydroxycarboxylic acid. In embodiments, a lithium beneficiary collected in accordance with any of the methods described herein includes a higher yield of lithium at a selected purity, measured as Li₂O, than a beneficiary obtained using the same methodology and the same overall amount of collector actives, but in the absence of the hydroxycarboxylic acid. Other objects and features will be in part apparent and in part pointed out hereinafter.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

As used herein, “lithium ore”, “lithium ore source” and like terms refer to solid rock materials mined from one or more subterranean excavations, wherein the ore contains at least 10% by weight of a lithium-containing compound, for example about 10 wt % to 50 wt % of a lithium-containing compound. In embodiments the lithium ore source is a comminuted lithium ore, which is the as-mined lithium ore after one or more comminution processes such as crushing, milling and/or grinding. In embodiments the lithium ore is a “classified lithium ore”, which is a comminuted lithium ore that is further separated according to particle size, such as by a screening process, further wherein the classification is conducted substantially in the absence of a liquid. A lithium ore is not the same as a lithium brine, which is a lithium source that includes a liquid. In embodiments, the lithium ore excludes lithium brines.

As used herein, the term “beneficiation” refers to the processing of an ore slurry by froth flotation to obtain a mineral beneficiary therefrom. Lithium beneficiation includes separating a lithium-containing mineral beneficiary (“lithium beneficiary”) from the remaining ore materials (the “gangue”) by forming an aqueous slurry thereof; sparging the slurry with a gas such as air, causing the lithium-containing mineral to associate with bubbles in the slurry, wherein the bubbles subsequently rise and collect on the surface of the slurry to form a froth; and collecting the froth, which contains a lithium beneficiary, from the sparged slurry. The lithium beneficiary is enriched in the lithium-containing mineral when compared to the lithium-containing mineral content of the lithium ore.

As used herein, the term “active” to describe a component of a composition indicates that the component is a solid at a pressure of 1 atm and a temperature of 23° C.

As used herein, the term “solvent” to describe a component of a composition indicates that the component is a liquid at a pressure of 1 atm and a temperature of 23° C.

As used herein, the terms “comprise(s),” “include(s),” “having,” “has,” “can,” “contain(s),” and variants thereof are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “substantially” means “consisting essentially of”, which includes “consisting of”. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Discussion

Disclosed herein are methods of lithium ore beneficiation. The methods comprise, consist essentially of, or consist of combining a lithium ore source, a water source, and a collector composition to form a lithium beneficiation slurry; sparging the lithium beneficiation slurry; separating the sparged lithium beneficiation slurry to form a lithium beneficiary and a gangue; and collecting the lithium beneficiary, wherein the collector comprises, consists essentially of, or consists of a hydroxycarboxylic acid, a surfactant, and a solvent.

In embodiments, the lithium ore source comprises, consists essentially of, or consists of a pegmatite, a Zinnwaldite, a Jadarite, or a lithium mica. The lithium ore source is a solid material mined from one or more subterranean excavations and containing at least 0.1% by weight of a lithium-bearing compound or mineral, such as spodumene, calculated as wt % Li₂O: stated differently, a suitable lithium ore source has a “lithium potential” of at least 0.1% lithium as Li₂O. In embodiments, the lithium ore source has a lithium potential between 0.1% and 10% lithium as Li₂O, for example 0.5% to 8%, or 1% to 8%, or 1% to 6%, often between 1% and 4% lithium as Li₂O. In embodiments the lithium ore source further includes one or more of quartz, clay, feldspar, or another mineral having silicon, aluminum, iron, and/or magnesium content.

In embodiments the lithium ore source is an “as-mined” or “raw” lithium ore, which is the rock product produced by mining operations without further modification. In other embodiments, the lithium ore beneficiation methods herein further include comminuting the lithium ore source and/or classifying the lithium ore source prior to combining the lithium ore source with the water source, collector, and optional frother components. In embodiments the lithium ore source is a comminuted lithium ore source, which is the as-mined lithium ore source after one or more comminution processes such as crushing, milling, grinding, or a combination thereof. In embodiments the lithium ore source ere is a classified lithium ore source, which is a lithium ore source that is separated according to particle size, such as by a screening process, further wherein the classification is conducted substantially in the absence of a liquid. In embodiments the lithium ore source ere is a comminuted, classified lithium ore source, wherein the lithium ore source is both comminuted and classified, either sequentially or in a continuous circuit to produce a lithium ore source having a suitable particle size for beneficiation.

The purpose of classifying a lithium ore source is to provide a particulate lithium ore source of appropriate size for one or more lithium beneficiation processes. In embodiments, classifying is contacting a comminuted lithium ore source with a screen, such that the lithium ore source particles passing through the screen are collected for beneficiation and the larger particulates retained by the screen are subjected to one or more additional comminution steps. In embodiments, a lithium ore source is comminuted, classified, or comminuted and classified while substantially dry, that is, in the absence of or substantial absence of aqueous or oily liquids such as water, paraffin oils or other petroleum oils, and the like. A common method of classification employed for ores is to pass a dry comminuted ore through a series of screens of decreasing mesh size, and select one or more captured ore particle size ranges retained by one or more of the screens. In embodiments, screening methods of classification are also employed to determine the average particle size range of a particulate, for example by weighing the fractions of ore particulate retained on the various mesh screens and determining an average particle size based on weight distribution.

One or more comminuted and/or classified lithium ore sources are suitably employed in a lithium beneficiation slurry according to the presently described compositions, uses, and methods. However, the presently described compositions, uses, and methods are not particularly limited as to particle size range or average particle size of the lithium ore source used in the lithium beneficiation slurry. Accordingly, in embodiments, a lithium ore source is not comminuted. In some embodiments, a lithium ore source is not classified. In some embodiments, a lithium ore source is comminuted but not classified. In some embodiments, a lithium ore source is classified but not comminuted. And in some embodiments, a lithium ore source is neither comminuted nor classified.

In embodiments, an average particle size of a classified lithium ore source is between about 150 mm and 0.1 m, for example about 100 mm to 0.1 m, or about 50 mm to 0.1 m, or about 30 mm to 0.1 m, or about 20 mm to 0.1 m, or about 10 mm to 0.1 m, or about 1 mm to 0.1 μm, or about 1 mm to 1 μm, or about 1 mm to 10 μm. In embodiments, the average particle size recited above is average particle diameter by mass, or “D50” (also “d50”). Where not otherwise specified, the value of D50 particle size is determined by a screening classification method. Other methods may be used to determine an average particle size, including D50 particle size; such methods include for example light scattering methods or liquid-based size exclusion methods.

In froth flotation, an ore is typically comminuted to provide an ore particulate having particles with a maximum dimension of several millimeters or less, in some cases a millimeter or less, for example particles having mesh of 35 (500 microns) or finer, or even 50 mesh (297 microns) or finer; and the comminuted ore is combined with water to form a slurry or pulp. In embodiments, a lithium ore source is combined with a water source to form a lithium ore slurry; and the collector composition and optional frother are added to the lithium ore source or the lithium ore slurry to form a lithium beneficiation slurry. In embodiments, the lithium beneficiation slurry includes about 10 wt % to 90 wt % of the lithium ore source, with the majority of the balance of the weight of the slurry being the water source. In embodiments, the lithium beneficiation slurry includes 20% solids by weight or more, for example 30 wt % lithium ore solids or more. In embodiments, a lithium beneficiation slurry includes about 10 wt % to 80 wt %, or about 20 wt % to 80 wt %, or about 30 wt % to 80 wt %, or about 40 wt % to 80 wt %, or about or about 20 wt % to 90 wt %, or about 30 wt % to 90 wt %, or about 40 wt % to 90 wt %, or about 50 wt % to 90 wt %, or about 60 wt % to 90 wt %, or about 10 wt % to 20 wt %, or about 10 wt % to 30 wt %, or about 20 wt % to 40 wt %, or about 30 wt % to 50 wt %, or about 40 wt % to 60 wt %, or about 50 wt % to 70 wt %, or about 60 wt % to 80 wt %, or about 70 wt % to 90 wt %, or about 80 wt % to 90 wt % of the lithium ore source, wherein the balance of the lithium beneficiation slurry comprises, consists essentially of, or consists of the water source, collector composition, and optional frother components.

In embodiments, the water source is water, tap water, fresh water, industrial wastewater from one or more mining operations, or another such source of water, which may further include up to 5 wt % total dissolved solids. In embodiments, the water source is a process water recovered from one or more industrial processes. In embodiments the industrial process is a lithium beneficiation process, wherein water recovered from an initial lithium beneficiation slurry after separation of the lithium beneficiary therefrom is recycled and employed as the water source in a subsequent lithium beneficiation process. In embodiments, the water source includes one or more pH adjustment agents. A pH adjustment agent may be suitably added to a water source before or after the water source is contacted with the lithium ore source. Further, a pH adjustment agent is suitably added to a water source before and/or after the water source is contacted with any other component of the lithium beneficiation slurry. In embodiments, the pH of the water source is adjusted after the water source is contacted with the lithium ore. In embodiments, the methods disclosed herein include adjusting the pH of a lithium beneficiation slurry to be between 7 and 10, for example 7.5 to 10, 7.5 to 9.0, 7.0 to 9.0, 7.5 to 8.5, or 7.0 to 8.5. In embodiments, a lithium beneficiation slurry has a pH of about 7 to 10, for example 7.5 to 10, 7.5 to 9.0, 7.0 to 9.0, 7.5 to 8.5, or 7.0 to 8.5. Suitable pH adjustment agents include NaOH (caustic, or lye), sodium carbonate (soda ash), or another strong base that is added to the water source before or after contact of the water source with the lithium ore source. In embodiments, the pH adjustment agent is added as an aqueous solution thereof, for example a 0.1 wt % to 10 wt % solution in water, for convenience of the operator and ease of mixing.

The lithium beneficiation slurry includes a lithium ore source, a water source, and a collector composition. In embodiments, the methods disclosed herein include adding a collector composition and a water source to a lithium ore source to form a lithium beneficiation slurry. In other embodiments, the collector composition is added to a lithium ore slurry to form a lithium beneficiation slurry. In still other embodiments, the collector composition and the water source are added contemporaneously to the lithium ore source to form a lithium beneficiation slurry; in some such embodiments, the water source and the collector composition are mixed, then the lithium ore source is added to this mixture to form a lithium beneficiation slurry.

In any of the foregoing embodiments, the water source and/or the components of the collector composition—that is, the hydroxycarboxylic acid, the surfactant, and the solvent, may be added in two or more portions, either separately or as a mixture of two or more components thereof, in any order, to facilitate efficiency of mixing the lithium ore source and/or the water source with the collector composition. Additionally, where the collector composition includes one or more of: a hydroxycarboxylic acid that includes a mixture of two or more hydroxycarboxylic acid species; a surfactant that includes a mixture of two or more surfactant species; or a solvent that includes a mixture of two or more solvent species, addition of these collector composition species to a lithium ore source or a lithium ore slurry may be carried out individually and separately, in any order, further in a single addition or in two or more portions thereof to form a lithium beneficiation slurry in accord with each and every disclosure herein.

In embodiments, the collector composition is added to a lithium ore source or a lithium ore slurry in an amount of about 10 ppm to 10,000 ppm based on the weight of the lithium ore source, for example 100 ppm to 10,000 ppm, or 100 ppm to 9000 ppm, or 100 ppm to 8000 ppm, or 100 ppm to 7000 ppm, or 100 ppm to 6000 ppm; or 100 ppm to 5000 ppm, or 100 ppm to 4000 ppm, or 100 ppm to 3000 ppm, or 100 ppm to 2000 ppm, or 100 ppm to 1000 ppm, or 100 ppm to 900 ppm, or 100 ppm to 800 ppm, or 100 ppm to 700 ppm, or 100 ppm to 600 ppm; or 100 ppm to 500 ppm, or 100 ppm to 400 ppm, or 100 ppm to 300 ppm, or 10 ppm to 100 ppm, or 100 ppm to 200 ppm, or 200 ppm to 300 ppm, or 300 ppm to 400 ppm, or 400 ppm to 500 ppm, or 500 ppm to 600 ppm, or 600 ppm to 700 ppm, or 700 ppm to 800 ppm, or 800 ppm to 900 ppm, or 900 ppm to 1000 ppm, or 1000 ppm to 2000 ppm, or 2000 ppm to 3000 ppm, or 3000 ppm to 4000 ppm, or 4000 ppm to 5000 ppm, or 5000 ppm to 6000 ppm, or 6000 ppm to 7000 ppm, or 7000 ppm to 8000 ppm, or 8000 ppm to 9000 ppm, or 9000 ppm to 10,000 ppm of the collector composition, based on the weight of the lithium ore, is added to a lithium ore source or a lithium ore slurry.

In embodiments, the collector composition is added to a lithium ore source or a lithium ore slurry in an amount of about 10 ppm to 10,000 ppm actives based on the weight of the lithium ore source, that, 10 ppm to 10,000 ppm total of a combination of hydroxycarboxylic acid and surfactant. In embodiments the combination is added as a mixture thereof to a lithium ore source or a lithium ore slurry. In other embodiments the combination is added as individual components thereof to a lithium ore source or a lithium ore slurry. Thus, for example, 10 ppm to 9000 ppm, or 10 ppm to 8000 ppm, or 10 ppm to 7000 ppm, or 10 ppm to 6000 ppm; or 10 ppm to 5000 ppm, or 10 ppm to 4000 ppm, or 10 ppm to 3000 ppm, or 10 ppm to 2000 ppm, or 10 ppm to 1000 ppm, or 10 ppm to 900 ppm, or 10 ppm to 800 ppm, or 10 ppm to 700 ppm, or 10 ppm to 600 ppm; or 10 ppm to 500 ppm, or 10 ppm to 400 ppm, or 10 ppm to 300 ppm, or 10 ppm to 200 ppm or 10 ppm to 100 ppm, or 10 ppm to 90 ppm, or 10 ppm to 80 ppm, or 10 ppm to 70 ppm, or 10 ppm to 60 ppm, or 10 ppm to 50 ppm, or 10 ppm to 40 ppm, or 10 ppm to 30 ppm, or 10 ppm to 20 ppm, or 20 ppm to 30 ppm, or 30 ppm to 40 ppm, or 40 ppm to 50 ppm, or 50 ppm to 60 ppm, or 60 ppm to 70 ppm, or 70 ppm to 80 ppm, or 80 ppm to 90 ppm, or 90 ppm to 100 ppm, or 100 ppm to 200 ppm, or 200 ppm to 300 ppm, or 300 ppm to 400 ppm, or 400 ppm to 500 ppm, or 500 ppm to 600 ppm, or 600 ppm to 700 ppm, or 700 ppm to 800 ppm, or 800 ppm to 900 ppm, or 900 ppm to 1000 ppm, or 1000 ppm to 2000 ppm, or 2000 ppm to 3000 ppm, or 3000 ppm to 4000 ppm, or 4000 ppm to 5000 ppm, or 5000 ppm to 6000 ppm, or 6000 ppm to 7000 ppm, or 7000 ppm to 8000 ppm, or 8000 ppm to 9000 ppm, or 9000 ppm to 10,000 ppm collector composition actives, based on the weight of the lithium ore, are added to a lithium ore source or a lithium ore slurry.

In embodiments, the collector compositions or any one or more of the individual components thereof are added to a lithium ore source or a lithium ore slurry in accord with the methods, uses, and kits described herein. Unless otherwise stated or determined by context, statements regarding the percent of a collector component in a collector composition means percent of the active component (“neat” or 100% solids), with respect to the total amount of actives in the collector composition. In embodiments, the amounts of the collector composition components, and/or the amount of the collector composition added or applied to a lithium ore source or to a lithium ore slurry are expressed herein as “actives” or “solids” where the collector composition comprises the components thereof. In such embodiments, in the context of the disclosures herein, the solvent component of the collector composition is also considered an “active” component.

In embodiments, the hydroxycarboxylic acid comprises, consists essentially of, or consists of a C10 to C28 hydroxycarboxylic acid or a conjugate base thereof, as well as mixtures of two or more C10 to C28 hydroxycarboxylic acids and/or their conjugate bases. In embodiments, a conjugate base of a hydroxycarboxylic acid, that is, a hydroxycarboxylate, includes or is associated with a counterion selected from lithium, sodium, potassium, calcium, zinc, magnesium, ammonium, alkylammonium, and alkanolammonium. Unless further limited by specifically or by context, as used herein the term “hydroxycarboxylic acid” means a C10 to C28 hydroxycarboxylic acid; a mixture of two or more C10 to C28 hydroxycarboxylic acids; a C10 to C28 hydroxycarboxylate; a mixture of two or more C10 to C28 hydroxycarboxylates; or a mixture of one or more C10 to C28 hydroxycarboxylic acids with one or more C10 to C28 hydroxycarboxylates, in any ratio. That is, unless further limited by specifically or by context, as used herein the term “hydroxycarboxylic acid” means a hydroxycarboxylic acid, a conjugate base thereof, or a mixture thereof. The hydroxycarboxylic acid includes alkyl (normal or branched), alkenyl, alkaryl, or aralkenyl functionality. In embodiments the hydroxycarboxylic acid comprises, consists essentially of, or consists of a C16 to C22 hydroxycarboxylic acid or a conjugate base thereof. In embodiments the hydroxycarboxylic acid comprises, consists essentially of, or consists of a C18 hydroxycarboxylic acid or a conjugate base thereof. In embodiments, the hydroxycarboxylic acid includes between one and five hydroxyl groups. In embodiments, the hydroxycarboxylic acid includes a hydroxyl group situated α-, β-, or γ- to the carboxylic acid moiety. In embodiments the hydroxycarboxylic acid is a o-hydroxycarboxylic acid, wherein a hydroxyl group is situated on the terminal carbon, for example 16-hydroxypalmitic acid or 18-hydroxystearic acid. In embodiments the hydroxycarboxylic acid includes an alkenyl functionality and is a hydroxylated C16-, C18-, C20- or C22-(mono) unsaturated fatty acid. In embodiments the hydroxycarboxylic acid is a hydroxylated C16-, C18-, C20- or C22-polyunsaturated fatty acid.

In embodiments, the hydroxycarboxylic acid comprises, consists essentially of, or consists of ricinoleic acid (12-hydroxy-9-cis-octadecenoic acid). In embodiments, the hydroxycarboxylic acid comprises ricinelaidic acid (12-hydroxy-9-trans-octadecenoic acid), lesquerolic acid (14-hydroxy-11-cis-eicosenoic acid) or a mixture of two or more thereof; in some such embodiments, the mixture further includes ricinoleic acid. In embodiments, the ricinoleic acid includes 0.1 wt % to 2 wt % oleic acid, and the collector composition includes 0 wt % to 1 wt % oleic acid. In such embodiments, the collector compositions are characterized as excluding or substantially excluding oleic acid.

In embodiments, the hydroxycarboxylic acid is a dihydroxycarboxylic acid, for example a 3,5-dihydroxycarboxylic acid or a dihydroxycarboxylic acid described in EP1318138 to BASF Aktiengesellschaft. In embodiments, a conjugate base of the hydroxycarboxylic acid is a sodium, potassium, or lithium, calcium, or zinc hydroxycarboxylate.

In embodiments, the collector composition includes about 10 wt % to 50 wt % of the hydroxycarboxylic acid or hydroxycarboxylate as a percent of the collector composition or as a percent of actives in the collector composition, for example 10 wt % to 45 wt %, or 10 wt % to 40 wt %, or 10 wt % to 35 wt %, or 10 wt % to 30 wt %, or 10 wt % to 25 wt %, or 10 wt % to 20 wt %, or 10 wt % to 15 wt %, or 15 wt % to 50 wt %, or 20 wt % to 50 wt %, or 25 wt % to 50 wt %, or 30 wt % to 50 wt %, or 35 wt % to 50 wt %, or 40 wt % to 50 wt %, or 45 wt % to 50 wt %, or 10 wt % to 12 wt %, or 12 wt % to 15 wt %, or 15 wt % to 17 wt %, or 17 wt % to 20 wt %, or 20 wt % to 22 wt %, or 22 wt % to 25 wt %, or 25 wt % to 27 wt %, or 27 wt % to 30 wt %, or 30 wt % to 35 wt %, or 35 wt % to 40 wt %, or 40 wt % to 45 wt %, or 45 wt % to 50 wt % of the hydroxycarboxylic acid as a percent of collector composition or as a percent of actives in the collector composition.

In embodiments, the surfactant component of the collector composition comprises, consists essentially of, or consists of an anionic surfactant, a nonionic surfactant, or any combination thereof. In embodiments, the collector composition includes about 10 wt % to 50 wt % total surfactant as a percent of collector composition or as a percent of actives in the collector composition, for example 10 wt % to 45 wt %, or 10 wt % to 40 wt %, or 10 wt % to 35 wt %, or 10 wt % to 30 wt %, or 10 wt % to 25 wt %, or 10 wt % to 20 wt %, or 10 wt % to 15 wt %, or 15 wt % to 50 wt %, or 20 wt % to 50 wt %, or 25 wt % to 50 wt %, or 30 wt % to 50 wt %, or 35 wt % to 50 wt %, or 40 wt % to 50 wt %, or 45 wt % to 50 wt %, or 10 wt % to 12 wt %, or 12 wt % to 15 wt %, or 15 wt % to 17 wt %, or 17 wt % to 20 wt %, or 20 wt % to 22 wt %, or 22 wt % to 25 wt %, or 25 wt % to 27 wt %, or 27 wt % to 30 wt %, or 30 wt % to 35 wt %, or 35 wt % to 40 wt %, or 40 wt % to 45 wt %, or 45 wt % to 50 wt % surfactant as a percent of collector composition or as a percent of actives in the collector composition.

Where the surfactant comprises, consists essentially of, or consists of a combination of one or more nonionic surfactants and one or more anionic surfactants, the ratio of total anionic to total nonionic surfactants in the collector composition is between 100:1 and 1:1 by weight, such as 100:1 to 1:1, or 90:1 to 1:1, or 80:1 to 1:1, or 70:1 to 1:1, or 60:1 to 1:1, or 50:1 to 1:1, or 40:1 to 1:1, or 30:1 to 1:1, or 20:1 to 1:1, or 10:1 to 1:1, or 9:1 to 1:1, or 8:1 to 1:1, or 7:1 to 1:1, or 6:1 to 1:, or 5:1 to 1:1, or 4:1 to 1:1, or 3:1 to 1:1, or 2:1 to 1:1, or 10:1 to 5:1, or 10:1 to 2:1, or 5:1 to 2:1, or 5:1 to 3:1, or 10:1 to 3:1, or about 100:1, 90:1, 80:1, 70:1, 60:1, 50:1, 40:1, 30:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or 1:1 by weight of total anionic to total nonionic surfactants in the collector composition.

Suitable nonionic surfactants have at least one polyalkoxylated moiety and at least one alkyl, alkenyl, aryl, aralkyl, or aralkenyl moiety having 10 to 22 carbons. Examples of suitable nonionic surfactants include polyethoxylated and poly(ethoxylated/propoxylated) adducts of C10-C22 alkyl, alkenyl, aryl, aralkyl, or aralkenyl alcohols or C10-C22 fatty acids; and glycerol polyols functionalized with one or more C10-C22 alkyl, alkenyl, aryl, or alkaryl moieties. In embodiments, one or more C10-C22 alkyl, alkenyl, aryl, aralkyl, or aralkenyl moieties further include one or more heteroatoms such as N, O, Cl, F, or S. In embodiments, one or more C10-C22 alkenyl moieties include two or more unsaturated sites, for example a polyethoxylated adduct of a polyunsaturated fatty acid having 2, 3, or more unsaturated sites. In embodiments, one or more C10-C22 alkyl, alkenyl, aryl, aralkyl, or aralkenyl moieties includes 12 to 22 carbon atoms, or 12 to 20 carbons, or 12 to 18 carbons, or 14 to 22 carbons, or 16 to 22 carbons, or 16 to 20 carbons, or 16 to 18 carbons, or 18 to 22 carbons, or 18 to 20 carbons. In embodiments the number of carbons recited for an alkyl, alkenyl, aryl, aralkyl, or aralkenyl moiety represents a range or average value of number of carbons, as determined by context.

Polyalkoxylated C10-C22 alkyl, alkenyl, aryl, aralkyl, or aralkenyl alcohols and polyalkoxylated C10-C22 fatty acids are well known and widely commercially available. In embodiments, a polyethoxylated or poly(ethoxylated/propoxylated) moiety has an average molecular weight of about 84 g/mol to 10,000 g/mol. In embodiments, the nonionic surfactant comprises, consists essentially of, or consists of a polyalkoxylated sorbitan fatty acid ester. Polyalkoxylated sorbitan fatty acid esters having one or more polyethylene oxide groups, and one or more C10-C22 alkyl or alkenyl moieties are commercially available under the trade name TWEEN®, such as TWEEN®-80 (polyoxyethylene sorbitan monooleate, also sold under the trade name polysorbate-80) and TWEEN®-20 (polyoxyethylene sorbitan monolaurate, also sold under the trade name polysorbate-20).

In embodiments, glycerol polyols functionalized with one or more C10-C22 alkyl, alkenyl, aryl, aralkyl, or aralkenyl moieties are formed from polyglycerols, polyglycerol derivatives, polyols having glycerol-based monomer units and polyethoxylated or poly(ethoxylated/propoxylated) units, or combinations thereof. The glycerol monomer units and glycerol-based monomer units are selected from the following structures I-VIII:

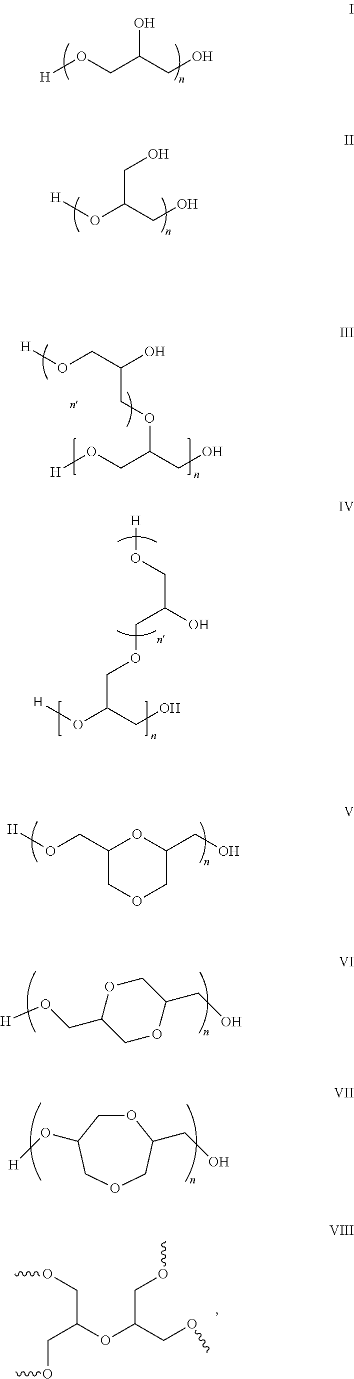

where each n and n′ is independently any integer.

Glycerol polyols are formed by condensation of glycerol. In some embodiments, the condensation results in the 6- or 7-membered ring structures V-VII shown above. In embodiments, a glycerol polyol has a degree of cyclization of about 0.01 to about 0.19, for example 0.15 to 0.18, wherein “degree of cyclization” means the mole fraction of cyclic structure units, such as structures V-VII above, relative to the total glycerol units in the polymer. The degree of cyclization may be suitably determined by ¹³C NMR. In embodiments, a glycerol polyol has an average molecular weight of about 166 g/mol to 10,000 g/mol. Any one or more hydroxyl moieties present in structures I-VIII may be suitably functionalized with one or more C10-C22 alkyl, alkenyl, aryl, aralkyl, or aralkenyl moieties as described above.

In embodiments, a nonionic surfactant is characterized as having a hydrophilic/lipophilic balance (HLB) of between 1 and 20. The HLB of the nonionic surfactant in embodiments is about 1-5, 5-10, 10-15, 15-20, 1-10, 10-20, 5-15, 12-6, 3-7, 4-8, 5-9, 6-10, 7-11, 8-12, 9-13, 10-14, 11-15, 12-16, 13-17, 14-18, 15-19, 16-20, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 2-18, 2-15, 5-18, 7-15, 8-15, or 5-12.

In embodiments, the anionic surfactant component of the collector composition comprises, consists essentially of, or consists of a sulfonated surfactant, a dianionic surfactant, or a combination thereof. Suitable sulfonated surfactants are compounds including one sulfonate or sulfate moiety and at least one alkyl, alkenyl, aryl, aralkyl, or aralkenyl moiety having 10 to 22 carbons. In embodiments, one or more C10-C22 alkyl, alkenyl, aryl, aralkyl, or aralkenyl moieties further include one or more heteroatoms such as N, O, Cl, F, or S. In embodiments, one or more C10-C22 alkyl, alkenyl, aryl, aralkyl, or aralkenyl moieties include two or more unsaturated sites, for example a sulfonated adduct of a polyunsaturated fatty acid having 2, 3, or more unsaturated sites. In embodiments, one or more C10-C22 alkyl, alkenyl, aryl, aralkyl, or aralkenyl moieties includes 12 to 22 carbon atoms, or 12 to 20 carbons, or 12 to 18 carbons, or 14 to 22 carbons, or 16 to 22 carbons, or 16 to 20 carbons, or 16 to 18 carbons, or 18 to 22 carbons, or 18 to 20 carbons. In embodiments the number of carbons recited for an alkyl, alkenyl, aryl, aralkyl, or aralkenyl moiety represents a range or average value of number of carbons, as determined by context. A broad range of sulfonated surfactants are commercially available, including for example sodium dodecyl (lauryl) sulfonate, sodium stearyl sulfonate, sodium or potassium salts of sulfonated 9-octadecenoic acid, and the like.

In embodiments, suitable dianionic surfactants include two carboxylate moieties, two sulfonate moieties, or two sulfate moieties; and at least one alkyl, alkenyl, aryl, or alkaryl moiety having 10 to 22 carbons. In embodiments, one or more C10-C22 alkyl, alkenyl, aryl, aralkyl, or aralkenyl moieties further include one or more heteroatoms such as N, O, Cl, F, or S. In embodiments, one or more C10-C22 alkyl, alkenyl, aryl, aralkyl, or aralkenyl moieties include two or more unsaturated sites. In embodiments, one or more C10-C22 alkyl, alkenyl, aryl, aralkyl, or aralkenyl moieties includes 12 to 22 carbon atoms, or 12 to 20 carbons, or 12 to 18 carbons, or 14 to 22 carbons, or 16 to 22 carbons, or 16 to 20 carbons, or 16 to 18 carbons, or 18 to 22 carbons, or 18 to 20 carbons. In embodiments the number of carbons recited for an alkyl, alkenyl, aryl, aralkyl, or aralkenyl moiety represents a range or average value of number of carbons, as determined by context.

In embodiments, the dianionic surfactant comprises, consists essentially of, or consists of a substituted succinic acid compound having the formula HOOC—CH(R)—CH₂—COOH, where R is a substituent selected from C10-C22 alkyl, alkenyl, aryl, aralkyl, or aralkenyl optionally including one or more heteroatoms such as N, O, Cl, F, or S. In embodiments, the dianionic surfactant comprises, consists essentially of, or consists of a conjugate base of a substituted succinic acid compound, that is, a substituted succinate, having the formula XOOC—CH(R)—CH₂—COOY, wherein R is a substituent selected from C10-C22 alkyl, alkenyl, aryl, aralkyl, or aralkenyl optionally including one or more heteroatoms such as N, O, Cl, F, or S; and X and Y are independently selected from hydrogen, lithium, sodium, potassium, calcium, zinc, magnesium, ammonium, alkylammonium, and alkanolammonium, further wherein at least one of X and Y is not hydrogen. In embodiments, the dianionic surfactant comprises, consists essentially of, or consists of a mixture of a substituted succinic acid and a substituted succinate. In some such embodiments, the substituted succinic acid compound and the substituted succinate compound have the same R substituent, and the dianionic surfactant comprises, consists essentially of, or consists of a compound having the formula XOOC—CH(R)—CH₂—COOY, where R is a substituent selected from C10-C22 alkyl, alkenyl, aryl, aralkyl, or aralkenyl optionally including one or more heteroatoms such as N, O, Cl, F, or S; and X and Y are independently selected from hydrogen, lithium, sodium, potassium, calcium, zinc, magnesium, ammonium, alkylammonium, and alkanolammonium.

Accordingly and unless further limited specifically or by context, as used herein the term “substituted succinic acid” or “substituted succinic acid compound” means a compound or a mixture of one or more compounds having the structure XOOC—CH(R)—CH—COOY, wherein R is alkyl, alkenyl, aralkyl, or aralkenyl group having 10 to 22 carbons and X and Y are independently selected from hydrogen, lithium, sodium, potassium, calcium, zinc, magnesium, ammonium, alkylammonium, and alkanolammonium.

In embodiments, the solvent comprises, consists essentially of, or consists of methanol, ethanol, isopropanol, n-propanol, n-butanol, isobutanol, ethylene glycol, propylene glycol, 2-methoxyethanol (methyl cellosolve), 2-butoxyethanol (butyl cellosolve), diethylene glycol, 2-(2-methoxyethoxy)ethanol, bis(2-methoxyethyl) ether (diglyme), triethylene glycol, glycerol, ethyl acetate, acetone, methyl ethyl ketone, and triacetin, as well as mixtures of two or more of these. In embodiments, the solvent is an aqueous solvent comprising, consisting essentially of, or consisting of one or more of the foregoing solvents mixed with water or a water source. Where the solvent is an aqueous solvent, the water and solvent are present in the collector composition in a water:solvent weight ratio of between 50:1 and 1:1, such as 40:1 to 1:1, 30:1 to 1:1, 20:1 to 1:1, 10:1 to 1:1, 9:1 to 1:1, 8:1 to 1:1, 7:1 to 1:1, 6:1 to 1:1, 5:1 to 1:1, 4:1 to 1:1, 3:1 to 1:1, or 2:1 to 1:1.

In embodiments, the collector composition includes about 3 wt % to 70 wt % of the solvent as a percent of the collector composition, for example 3 wt % to 70 wt %, or 3 wt % to 65 wt %, or 3 wt % to 60 wt %, or 3 wt % to 55 wt %, or 3 wt % to 50 wt %, or 3 wt % to 45 wt %, or 3 wt % to 40 wt %, or 3 wt % to 35 wt %, or 3 wt % to 30 wt %, or 3 wt % to 25 wt %, or 3 wt % to 20 wt %, or 3 wt % to 15 wt %, or 10 wt % to 70 wt %, or 10 wt % to 65 wt %, or 10 wt % to 60 wt %, or 10 wt % to 55 wt %, or 10 wt % to 50 wt %, or 10 wt % to 45 wt %, or 10 wt % to 40 wt %, or 10 wt % to 35 wt %, or 10 wt % to 30 wt %, or 10 wt % to 25 wt %, or 10 wt % to 20 wt %, or 10 wt % to 15 wt %, or or 10 wt % to 12 wt %, or 12 wt % to 15 wt %, or 15 wt % to 17 wt %, or 17 wt % to 20 wt %, or 20 wt % to 22 wt %, or 22 wt % to 25 wt %, or 25 wt % to 27 wt %, or 27 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt % of the solvent as a percent of collector composition.

Stated differently, in embodiments the collector composition includes about 30 wt % to 97 wt % actives, for example 97 wt % to 30 wt %, or 97 wt % to 35 wt %, or 97 wt % to 40 wt %, or 97 wt % to 45 wt %, or 97 wt % to 50 wt %, or 97 wt % to 55 wt %, or 97 wt % to 60 wt %, or 97 wt % to 65 wt %, or 97 wt % to 70 wt %, or 97 wt % to 75 wt %, or 97 wt % to 80 wt %, or 97 wt % to 85 wt %, or 90 wt % to 30 wt %, or 90 wt % to 35 wt %, or 90 wt % to 40 wt %, or 90 wt % to 45 wt %, or 90 wt % to 50 wt %, or 90 wt % to 55 wt %, or 90 wt % to 60 wt %, or 90 wt % to 65 wt %, or 90 wt % to 70 wt %, or 90 wt % to 75 wt %, or 90 wt % to 80 wt %, or 90 wt % to 85 wt %, or 90 wt % to 88 wt %, or 88 wt % to 85 wt %, or 85 wt % to 83 wt %, or 83 wt % to 80 wt %, or 80 wt % to 78 wt %, or 78 wt % to 75 wt %, or 75 wt % to 73 wt %, or 73 wt % to 70 wt %, or 70 wt % to 65 wt %, or 65 wt % to 60 wt %, or 60 wt % to 55 wt %, or 55 wt % to 50 wt %, or 50 wt % to 45 wt %, or 45 wt % to 40 wt %, or 40 wt % to 35 wt %, or 35 wt % to 30 wt % actives as a percent of collector composition, where actives in the collector composition comprise, consist essentially of, or consist of the hydroxycarboxylic acid and the surfactant.

Accordingly, disclosed herein are lithium ore beneficiation slurries comprising, consisting essentially of, or consisting of a mixture of a lithium ore source, a water source, and a collector composition, wherein the collector composition comprises, consists essentially of, or consists of a hydroxycarboxylic acid, a surfactant, and a solvent. In embodiments, the lithium ore source comprises, consists essentially of, or consists of pegmatite, a Zinnwaldite, a Jadarite, or a lithium mica. In embodiments, the lithium ore source excludes lithium brines, that is, lithium-bearing compounds dissolved or dispersed in a liquid. In embodiments, the lithium ore source comprises, consists essentially of, or consists of a comminuted lithium ore source, or a classified lithium ore source, or a comminuted, classified lithium ore source. In embodiments, the hydroxycarboxylic acid comprises, consists essentially of, or consists of a C10 to C28 hydroxycarboxylic acid. In embodiments the hydroxycarboxylic acid comprises, consists essentially of, or consists of a C16 to C20 hydroxycarboxylic acid. In embodiments, the hydroxycarboxylic acid includes one hydroxyl group; in other embodiments the hydroxycarboxylic acid includes two or even three hydroxyl groups. In embodiments, the hydroxycarboxylic acid comprises, consists essentially of, or consists of ricinoleic acid. In embodiments, the surfactant comprises, consists essentially of, or consists of an anionic surfactant, a nonionic surfactant, or combination thereof. In embodiments, the anionic surfactant comprises, consists essentially of, or consists of a dianionic surfactant, a sulfonated surfactant, or a combination thereof. In embodiments, the solvent comprises, consists essentially of, or consists of an aqueous solvent.

Also disclosed herein are uses of a collector composition comprising, consisting essentially of, or consisting of using a mixture of a hydroxycarboxylic acid, a surfactant, and a solvent to obtain increased yield of a lithium beneficiary, higher purity of a lithium beneficiary, or both in a lithium ore froth flotation, when compared to the yield, purity, or both of the same lithium mineral ore source but in the absence of the hydroxycarboxylic acid.

In embodiments, the collector composition is present in a lithium beneficiation slurry in an amount of 0.01 gram to 10 grams of the collector composition actives (solids) per kg of the lithium ore source, that is, 10 ppm to 10,000 ppm by weight of the lithium ore source. For example, in embodiments, collector composition actives are present in the lithium beneficiation slurry in an amount of 0.01 g to 9 g, 0.01 g to 8 g, 0.01 g to 7 g, 0.01 g to 6 g, 0.01 g to 5 g, 0.01 g to 4 g, 0.01 g to 3 g, 0.01 g to 2 g, 0.01 g to 1 g, 0.01 g to 0.5 g, 0.05 g to 10 g, 0.10 g to 10 g, 0.20 g to 10 g, 0.30 g to 10 g, 0.40 g to 10 g, 0.50 g to 10 g, 0.60 g to 10 g, 0.70 g to 10 g, 0.80 g to 10 g, 0.90 g to 10 g, 1.0 g to 10 g, 0.01 g to 0.05 g, 0.05 g to 0.10 g, 0.10 g to 0.50 g, 0.50 g to 1.0 g, 1.0 g to 2.0 g, 2.0 g to 3.0 g, 3.0 g to 4.0 g, 4.0 g to 5.0 g, 5.0 g to 6.0 g, 6.0 g to 7.0 g, 7.0 g to 8.0 g, 8.0 g to 9.0 g, or 9.0 g to 10.0 g of collector composition actives per 1000 g of the lithium ore slurry.

Also disclosed herein are methods of lithium ore beneficiation, wherein the method comprises adding any of the collector compositions disclosed herein to a lithium ore source in an amount of 0.01 gram to 10 grams of the collector composition actives per kg of the lithium ore source; and adding a water source to the combined lithium ore source and collector composition to form a lithium beneficiation slurry. In embodiments, the method comprises adding any of the collector compositions disclosed herein to a lithium ore slurry in an amount corresponding to about 0.01 gram to 10 grams of the collector composition actives per kg of the lithium ore source to form a lithium beneficiation slurry. In embodiments, the collector composition actives are added to a lithium ore source or a lithium ore slurry as a mixture thereof; in other embodiments, the hydroxycarboxylic acid and the surfactant are added individually (separately), either contemporaneously or serially to a lithium ore source or to a lithium ore slurry in any order to form a lithium beneficiation slurry. In embodiments where the hydroxycarboxylic acid and the surfactant are added individually to a lithium ore source or to a lithium ore slurry, the solvent is added as a mixture thereof with the hydroxycarboxylic acid, and optionally also as a separate mixture thereof with the surfactant, wherein the total amount of the three components of the collector composition added to a lithium ore source or to a lithium ore slurry is the same as discussed elsewhere herein.

In embodiments, the lithium ore source, the water source, the hydroxycarboxylic acid, and the surfactant are suitably contacted in any order to form a lithium beneficiation slurry. In embodiments, the hydroxycarboxylic acid is mixed with at least the solvent, or a portion of the solvent, prior to addition of the hydroxycarboxylic acid to a lithium ore source or a lithium ore slurry. If desired, the surfactant In embodiments, the hydroxycarboxylic acid, the surfactant, and the solvent are combined as a single mixture which is the collector composition; and the collector composition is added to a lithium ore source or a lithium ore slurry in one or more aliquots or doses. In embodiments, a lithium beneficiation slurry is stirred or otherwise agitated or mixed to disperse the collector composition components uniformly within the lithium beneficiation slurry.

After combining the lithium ore source, the water source, and the collector composition, the resulting lithium beneficiation slurry is sparged. In embodiments, the sparging comprises, consists essentially of, or consists of agitating the lithium beneficiation slurry, bubbling a gas through the lithium beneficiation slurry, or contemporaneously agitating and bubbling a gas through the lithium beneficiation slurry. In embodiments the gas comprises, consists essentially of, or consists of air or CO₂. The sparging causes gas bubbles to become dispersed throughout the lithium beneficiation slurry.

During sparging, the bubbles collect at the surface of the slurry, that is, the air-slurry interface, to form a froth. The froth is enriched in one or more lithium species (compounds) of interest, whereas the remaining slurry is depleted in one or more lithium species of interest. The froth is thus the lithium beneficiary, whereas the remaining slurry is the gangue. The lithium beneficiary is collected from the gangue for further processing and conversion to a lithium product, for example lithium carbonate or lithium hydroxide. In some embodiments, the lithium beneficiary, the gangue, or both are subjected to one or more additional froth flotation processes to increase yield, purity, or both of the desired lithium species, for example spodumene, further as discussed in embodiments below.

The lithium ore beneficiation methods described herein are suitable as batch or continuous processes. In any of the foregoing embodiments, two or more cycles of lithium ore beneficiation are suitably carried out in a flotation circuit in order to more fully deplete a lithium ore of the desired lithium species and/or increase the purity of the beneficiary that is collected. In embodiments, the foregoing methods described herein are directed to a first beneficiation process (first froth flotation) that is carried out in a first circuit stage, whereas second, third, fourth, or more beneficiation processes may be subsequently carried out using the separated beneficiary and gangue obtained in the first stage of the circuit, for second, third, fourth, or more circuit stages.

Flotation circuits include “rougher-scavenger” or “rougher-rougher/cleaner” type circuits and design variations of such circuits, wherein after a first beneficiation step, the gangue (also called tails) that remains after collection of the lithium beneficiary is recycled as feedstock to the original (first) flotation vessel for a second beneficiation, while the lithium beneficiary is applied as feedstock to a second flotation vessel and a separate, second beneficiation. A circuit further having a cleaner stage includes a third vessel that is fed by the gangue from the first vessel; the beneficiary from the cleaner/scavenger is then combined with feedstock to the first vessel, while the gangue from the cleaner/scavenger joins the gangue from the first vessel as the final gangue. Many variations on such flotation circuit systems are implemented globally and are familiar to one of ordinary skill in the art of froth flotation. Accordingly, the methods, uses, and compositions disclosed herein are suitably employed in connection with any conventional flotation apparatus or circuit for commercial scale production of lithium beneficiary from lithium ore sources.

Thus, disclosed herein are methods of combining a lithium ore source, a water source, and a collector composition to form a first lithium beneficiation slurry; sparging the first lithium beneficiation slurry; and separating a first lithium beneficiary from a first gangue, wherein the collector composition comprises, consists essentially of, or consists of a hydroxycarboxylic acid, a surfactant, and a solvent; applying the first lithium beneficiary, or the first gangue, or separately applying both the first lithium beneficiary and the first gangue to a second lithium ore beneficiation process, wherein the first lithium beneficiary and/or the first gangue are subjected to a second beneficiation by adding additional water source and collector composition to the first lithium beneficiary or the first gangue to form a second lithium beneficiation slurry; sparging the second lithium beneficiation slurry; and separating a second lithium beneficiary from a second gangue. In embodiments, first and second lithium beneficiaries, and optionally third, fourth, etc. lithium beneficiaries are combined to form a combined lithium beneficiary. In embodiments, a combined lithium beneficiary includes two or more lithium beneficiaries obtained by combining the lithium beneficiaries of two or more lithium ore beneficiation processes, for example from a flotation circuit. In embodiments, a combined gangue is formed by combining of the gangues of two or more lithium ore beneficiation processes, such as those separated within a flotation circuit.

The collector compositions described herein are used to achieve one or more unexpected benefits in lithium ore beneficiation, further in accord with the methods described herein. For example, in embodiments, a lithium beneficiary in accordance with any of the embodiments described herein obtains a yield of about 1 wt % to 30 wt % more lithium at a selected purity, measured as wt % Li₂O, than a beneficiary obtained with the same beneficiation slurry and with the same overall amount of collector actives, but in the absence of the hydroxycarboxylic acid. In embodiments, a lithium beneficiary, such as a first, second, third, fourth, or higher lithium beneficiary includes about 1 wt % to 3 wt %, or about 2 wt % to 4 wt %, or about 3 wt % to 5 wt %, or about 4 wt % to 6 wt %, or about 5 wt % to 7 wt %, or about 6 wt % to 8 wt %, or about 7 wt % to 9 wt %, or about 8 wt % to 10 wt %, or about 9 wt % to 11 wt %, or about 10 wt % to 12 wt %, or about 11 wt % to 13 wt %, or about 12 wt % to 14 wt %, or about 13 wt % to 15 wt %, or about 14 wt % to 16 wt %, or about 15 wt % to 17 wt %, or about 16 wt % to 18 wt %, or about 17 wt % to 19 wt %, or about 18 wt % to 20 wt %, or about 19 wt % to 21 wt %, or about 20 wt % to 22 wt %, or about 21 wt % to 23 wt %, or about 22 wt % to 24 wt %, or about 23 wt % to 25 wt %, or about 24 wt % to 26 wt %, or about 25 wt % to 27 wt %, or about 26 wt % to 28 wt %, or about 27 wt % to 29 wt %, or about 28 wt % to 30 wt %, or about 1 wt % to 5 wt %, or about 5 wt % to 10 wt %, or about 10 wt % to 15 wt %, or about 15 wt % to 20 wt %, or about 20 wt % to 25 wt %, or about 25 wt % to 30 wt % more lithium at a selected purity, measured as Li₂O, than a beneficiary obtained using the same methodology and the same overall amount of collector actives, but in the absence of the hydroxycarboxylic acid. In embodiments, the selected purity of the obtained yield is between about 4.0% Li₂O and 7.5% Li₂O, for example a selected purity between 4.0-7.0% Li₂O, or 4.0-6.0% Li₂O or 4.0-5.0% Li₂O, or 5.0-7.5% Li₂O, or 6.0-7.5% Li₂O, or 7.0-7.5% Li₂O, such as 4.0-4.2% Li₂O, 4.1-4.3% Li₂O, 4.2-4.4% Li₂O, 4.3-4.5% Li₂O, 4.4-4.6% Li₂O, 4.5-4.7% Li₂O, 4.6-4.8% Li₂O, 4.7-4.9% Li₂O, 4.8-5.0% Li₂O, 4.9-5.1% Li₂O, 5.0-5.2% Li₂O, 5.1-5.3% Li₂O, 5.2-5.4% Li₂O, 5.4-5.6% Li₂O, 5.5-5.7% Li₂O, 5.6-5.8% Li₂O, 5.7-5.9% Li₂O, 5.8-6.0% Li₂O, 5.9-6.1% Li₂O, 6.0-6.2% Li₂O, 6.1-6.3% Li₂O, 6.2-6.4% Li₂O, 6.3-6.5% Li₂O, 6.4-6.6% Li₂O, 6.5-6.7% Li₂O, 6.6-6.8% Li₂O, 6.7-6.9% Li₂O, 6.8-7.0% Li₂O, 6.9-7.1% Li₂O, 7.0-7.2% Li₂O, 7.1-7.3% Li₂O, 7.2-7.4% Li₂O, or 7.3-7.5% Li₂O.

Thus, in embodiments, a lithium beneficiary collected in accordance with any of the methods described herein obtains a yield of about 1 wt % to 30 wt % more lithium at a selected purity between 4.0% Li₂O and 7.5% Li₂O, than a beneficiary obtained with the same beneficiation slurry and with the same overall amount of collector actives, but in the absence of the hydroxycarboxylic acid. In one exemplary but nonlimiting embodiment, the yield of a lithium beneficiary having a purity of 5.0% Li₂O is 75% when 800 ppm actives of a collector composition in accordance with any of the foregoing collector compositions is added to the lithium ore source or lithium ore source or lithium ore slurry; whereas the yield of a lithium beneficiary having a purity of 5.0% Li₂O is only 65% when 800 ppm actives adding 800 ppm of the same collector composition absent the hydroxycarboxylic acid. That is, use of the hydroxycarboxylic acid results in a 10% increase in collected beneficiary 5.0% LiO₂. In another nonlimiting embodiment, the yield of a lithium beneficiary having a purity of 5.0% Li₂O is 95% when 800 ppm actives of a collector composition in accordance with any of the foregoing collector compositions is added to the lithium ore source or lithium ore source or lithium ore slurry; whereas the yield of a lithium beneficiary having a purity of 5.0% Li₂O is 65% when 800 ppm actives adding 800 ppm of the same collector composition absent the hydroxycarboxylic acid. That is, use of the hydroxycarboxylic acid results in a 30% increase in collected beneficiary having 5.0% LiO₂. Other examples are readily envisioned by one of skill.

In embodiments, a collector composition is provided as a kit for use by an operator for addition to a lithium ore source or a lithium ore slurry, along with instructions for adding or applying the collector composition to the lithium ore source or the lithium ore slurry and forming a lithium beneficiation slurry; and optionally further how to carry out froth flotation by sparging the lithium beneficiation slurry to form a froth, and collecting the froth to obtain a lithium beneficiary. In embodiments, the instructions included in the kit are consistent with the methods and uses of the collector composition as described herein. In some embodiments, the kit includes a mixture of the collector components in a selected ratio. In embodiments the kit includes instructions for adding or applying the collector composition to a lithium ore source, or to a lithium ore slurry prior to sparging, including instructions for the amount of the collector composition mixture or the individual components thereof to add based on the weight or the volume of a lithium ore source.

In other embodiments, the kit includes each of the collector composition components—that is, the hydroxycarboxylic acid, the surfactant, and the solvent—individually, and the instructions included in the kit further provide information about the amount of each component to combine to form a mixture thereof for addition to a lithium ore source or a lithium ore slurry to obtain a lithium beneficiation slurry. In embodiments, the information provided in a kit as described herein further includes information or instructions related to one or more of: adding components of the collector composition to a lithium ore source, adding components of the collector composition to a lithium ore slurry, mixing one or more of the collector composition components prior to adding the components to a lithium ore source or a lithium ore slurry, adding components of the collector composition sequentially, adding components of the collector composition contemporaneously, adding components of the collector composition in portions, adding components of the collector composition in a single addition, advising an order of addition of the collector composition components, and adjusting the pH of a lithium beneficiation slurry. Any of the process and use information disclosed herein is suitably included in the instructions provided with a collector composition kit, further in relation to addressing individual froth flotation processes carried out using variable equipment and/or for beneficiation of lithium ore sources having variable composition.

### EXPERIMENTAL SECTION

The following Flotation Test Procedure was used in one or more Examples below to determine yield and purity of lithium beneficiary obtained from lithium froth flotation processes.

Flotation Test Procedure

A flotation test apparatus fitted with a 2.8 L flotation cell (rougher) and having an impeller mixing mechanism and inlet for sparging the contents of the flotation cell was obtained from FLSmidth & Co. A/S of Copenhagen, Denmark. For each test, 1.0 kg of a lithium ore having a P80 particle size of less than 125 μm is added to a clean 2.8 L flotation cell, and either a plant process water or a municipal tap water is added to the flotation cell to reach a volume of 2.0 L. Process water is the raw water being used at the beneficiation plant.

If no amount of collector composition is specified in an Example below, then 1 g of collector composition actives, or 800 ppm by weight of the ore, is added to the flotation cell. The collector is added either neat or as dissolved or dispersed in a solvent where specified. Otherwise, the amount of collector composition added, along with any solvent employed, is specified in the Example. After the collector composition is added, 0.65 mL of a 7% w/w solution of soda ash is added to the flotation cell. Then the impeller is engaged to mix the contents of the flotation cell at a speed of 1000 rpm for 10 minutes; then mixing is stopped and additional process water (or tap water) is added to the flotation cell to reach the 2.8 L mark. The contents of the flotation cell are then mixed with the impeller at 1000 rpm for 30 seconds then maintained at 675 rpm throughout the test. A pressurized air supply is adjusted to provide a flow rate of 4 L/min and the air is injected into the contents of the flotation cell to sparge the contents. Sparging is timed and froth is collected from the surface of the flotation cell contents as follows:
a. Scrape the froth from the liquid surface three (3) times at 10 second intervals and collect in a separate vessel; this is Concentrate (or “Con”) 1.
b. Turn off the air flow (sparging) and replenish the process water/tap water in the flotation cell to 2.8 L.
c. Repeat steps a. and b. an additional two times, to collect Con 2 and Con 3, respectively.
d. Raise the air flow rate to 8 L/min for the last concentrate.
e. Scrape the froth from the liquid surface nine (9) times at 10 second intervals. All scrapings from this step are combined as Con 4.
f. Turn off impeller and air supply.

The remaining slurry (gangue) is set aside and allowed to settle for at least 3 hours, up to 12 hours, or even longer in case of slow settling fine particles. When settling is complete, as determined by the clarity of the supernatant liquid, the supernatant is decanted from the settled gangue solids. The concentrates are filtered, and the filtered solid beneficiary material is collected. The settled gangue solids, and separately the filtered beneficiary, are dried for at least 12 hours at 120° C. and then weighed.

Recovery of lithium as % Li₂O is determined by dividing the lithium weight in the recovered concentrate versus the lithium weight (as Li₂O) in the original feed. Purity of the recovered beneficiary, as Li₂O, is determined by dividing the concentrate lithium assay by the feed assay.

If no amount of collector composition is specified in an Example below, then 1 g of collector composition actives, or 800 ppm by weight of the ore, is added to the flotation cell. The collector is added either neat or as dissolved or dispersed in a solvent where specified. Otherwise, the amount of collector composition added, along with any solvent employed, is specified in the Example.

### Example 1

The components shown in Table 1 were admixed in the indicated amounts to form Collectors 1-7. Octadecenyl succinic anhydride includes both hexadecenyl succinic anhydride and mixed olefins having 15-20 carbons as impurities obtained along with the intended product. And sodium ricinoleate (sodium 12-hydroxyoleate) includes several minor impurities, the most common/highest concentrations of which are palmitate, oleate, stearate, and a 9,12 dienoate product.

TABLE 1
Components of Collectors 1-7, in wt %. Known impurities and amounts thereof
are listed following the component that is the source of the impurity.

| Collector | Component | Wt % | CAS No. |
|---|---|---|---|
| 1 | Octadecenyl succinic anhydride | 9.2 | 28777-98-2 |
| | Hexadecenyl succinic anhydride (impurity) | 0.5 | 32072-96-1 |
| | Mixed C15-20 Olefins (impurity) | 0.3 | 68603-32-7 |
| | Sodium 12-hydroxyoleate | 22.44 | 5323-95-5 |
| | Sodium palmitate (impurity) | 0.38 | 408-35-5 |
| | Sodium oleate (impurity) | 1.02 | 143-19-1 |
| | Sodium stearate (impurity) | 0.38 | 822-16-2 |
| | Sodium (9Z, 12Z)octadeca-9,12-dienoate (impurity) | 1.28 | 822-17-3 |
| | 9-Octadecenoic Acid (Z)-, Sulfonated, Potassium salt | 14.4 | 68609-93-8 |
| | 2-Butoxyethanol | 15 | 111-76-2 |
| | Water | 35 | 7732-18-5 |
| | Total Actives: 50 wt % | | |
| 2 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 24.2 | 5323-95-5 |
| | Sodium palmitate (impurity) | 0.41 | 408-35-5 |
| | Sodium oleate (impurity) | 1.1 | 143-19-1 |
| | Sodium stearate (impurity) | 0.41 | 822-16-2 |
| | Sodium (9Z, 12Z)octadeca-9,12-dienoate (impurity) | 1.38 | 822-17-3 |
| | 9-Octadecenoic Acid (Z)-, Sulfonated, Potassium salt | 18.0 | 68609-93-8 |
| | 2-Butoxyethanol | 8 | 111-76-2 |
| | Ethoxylated sorbitan monooleate | 3 | 9005-65-6 |
| | Water | 39.5 | 7732-18-5 |
| | Total Actives: 52.5 wt % | | |
| 3 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 15.84 | 5323-95-5 |
| | Sodium palmitate (impurity) | 0.27 | 408-35-5 |
| | Sodium oleate (impurity) | 0.72 | 143-19-1 |
| | Sodium stearate (impurity) | 0.27 | 822-16-2 |
| | Sodium (9Z, 12Z)octadeca-9,12-dienoate (impurity) | 0.9 | 822-17-3 |
| | 9-Octadecenoic Acid (Z)-, Sulfonated, Potassium salt | 30.0 | 68609-93-8 |
| | 2-Butoxyethanol | 4 | 111-76-2 |
| | Ethoxylated sorbitan monooleate | 3 | 9005-65-6 |
| | Ethylene oxide/propylene oxide C14-18 Alcohols | 2.9 | 68154-98-3 |
| | Tall oil acid, Potassium salt (impurity) | 0.033 | 61790-44-1 |
| | Tall oil fatty acid (impurity) | 0.059 | 61790-12-3 |
| | Water | 38 | 7732-18-5 |
| | Total Actives: 58 wt % | | |
| 4 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 24.2 | 5323-95-5 |
| | Palmitic acid, sodium salt (impurity) | 0.41 | 408-35-5 |
| | Sodium oleate (impurity) | 1.1 | 143-19-1 |
| | Sodium stearate (impurity) | 0.41 | 822-16-2 |
| | Sodium (9Z, 12Z)octadeca-9,12-dienoate (impurity) | 1.38 | 822-17-3 |
| | 9-Octadecenoic Acid (Z)-, Sulfonated, Potassium salt | 18.0 | 68609-93-8 |
| | Propylene glycol | 12.0 | 57-55-6 |
| | Ethoxylated sorbitan monooleate | 3 | 9005-65-6 |
| | Sodium lauryl sulfate | 1.5 | 151-21-3 |
| | Water | 43 | 7732-18-5 |
| | Total Actives: 45 wt % | | |
| 5 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 24.64 | 5323-95-5 |
| | Palmitic acid, sodium salt (impurity) | 0.42 | 408-35-5 |
| | Sodium oleate (impurity) | 1.12 | 143-19-1 |
| | Sodium stearate (impurity) | 0.42 | 822-16-2 |
| | Sodium (9Z, 12Z)octadeca-9,12-dienoate (impurity) | 1.4 | 822-17-3 |
| | 9-Octadecenoic Acid (Z)-, Sulfonated, Potassium salt | 18 | 68609-93-8 |
| | Propylene glycol | 4 | 57-55-6 |
| | Ethoxylated sorbitan monooleate | 3 | 9005-65-6 |
| | Water | 30.8 | 7732-18-5 |
| | Total Actives: 65.2 wt % | | |
| 6 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 15.84 | 5323-95-5 |
| | Palmitic acid, sodium salt (impurity) | 0.27 | 408-35-5 |
| | Sodium oleate (impurity) | 0.72 | 143-19-1 |
| | Sodium stearate (impurity) | 0.27 | 822-16-2 |
| | Sodium (9Z, 12Z)octadeca-9,12-dienoate (impurity) | 0.9 | 822-17-3 |
| | 9-Octadecenoic Acid (Z)-, Sulfonated, Potassium salt | 30.0 | 68609-93-8 |
| | Propylene glycol | 3 | 57-55-6 |
| | Ethoxylated sorbitan monooleate | 3 | 9005-65-6 |
| | Sodium lauryl sulfate | 1.2 | 151-21-3 |
| | Water | 40.8 | 7732-18-5 |
| | Total Actives: 56.2 wt % | | |
| 7 | Octadecenyl succinic anhydride | 3.68 | 28777-98-2 |
| | Hexadecenyl succinic anhydride (impurity) | 0.2 | 32072-96-1 |
| | Mixed C15-20 Olefins (impurity) | 0.12 | 68603-32-7 |
| | Sodium 12-hydroxyoleate | 24.2 | 5323-95-5 |
| | Palmitic acid, sodium salt (impurity) | 0.41 | 408-35-5 |
| | Sodium oleate (impurity) | 1.1 | 143-19-1 |
| | Sodium stearate (impurity) | 0.41 | 822-16-2 |
| | Sodium (9Z, 12Z)octadeca-9,12-dienoate (impurity) | 1.38 | 822-17-3 |
| | 9-Octadecenoic Acid (Z)-, Sulfonated, Potassium salt | 18 | 68609-93-8 |
| | Propylene glycol | 8 | 57-55-6 |
| | Ethoxylated sorbitan monooleate | 3 | 9005-65-6 |
| | Water | 39.5 | 7732-18-5 |
| | Total Actives: 52.5 wt % | | |

### Example 2

Collectors 1 and 2 were subjected to the Flotation Test Procedure, wherein 800 ppm of the Collectors by weight were added in the test as specified. Accordingly, Collector 1 was added at 400 ppm actives, and Collector 2 was added at 416 ppm actives.

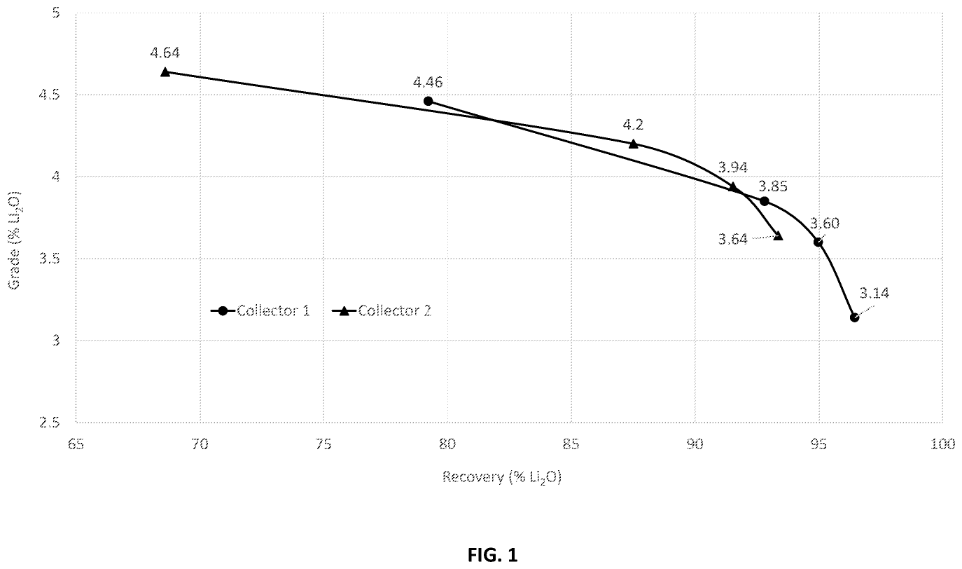

Grade % of lithium as Li₂O, that is, purity of the collected froth product in the Flotation Test, was determined as a function of percent Li₂O recovered from the ore. A plot showing grade % of lithium as Li₂O as a function of percent Li₂O recovered for Collector 1 and Collector 2 is shown in FIG. 1.

Table 2 shows grade and % recovery of Li₂O for concentrates Con 1-Con 4, as collected for Collectors 1 and 2 in the Flotation Test Procedure. The addition of ethoxylated sorbitan monooleate as a nonionic surfactant in Collector 2 increased the selectivity of the composition overall, such that greater than 65% yield of a product having Li₂O grade of 4.64% was obtained by froth flotation of an ore employing 416 ppm Collector 2 actives, whereas Collector 1 obtained no product having Li₂O grade of greater than 4.46% when applied at 400 ppm actives.

TABLE 2
Grade and % recovery of lithium as Li₂O for
concentrates Con 1-Con 4 of Example 2.

| | | Con 1 | Con 2 | Con 3 | Con 4 |
|---|---|---|---|---|---|
| Collector 1 | Grade, % Li₂O | 4.46 | 3.85 | 3.60 | 3.14 |
| | Recovery, wt % | 79.22 | 92.8 | 94.97 | 96.44 |
| Collector 2 | Grade, % Li₂O | 4.64 | 4.2 | 3.94 | 3.64 |
| | Recovery, wt % | 68.6 | 87.51 | 91.53 | 93.35 |

### Example 3

Collectors 2, 3, 4, 5, 6, and 7 were subjected to the Flotation Test Procedure, wherein 800 ppm of each of the Collectors by weight were added in the test, as specified. Accordingly, Collector 2 was added at 420 ppm actives, Collector 3 was added at 464 ppm actives, Collector 4 was added at 360 ppm actives, Collector 5 was added at 521.6 ppm actives, Collector 6 was added at 449.6 ppm actives, and Collector 7 was added at 420 ppm actives.

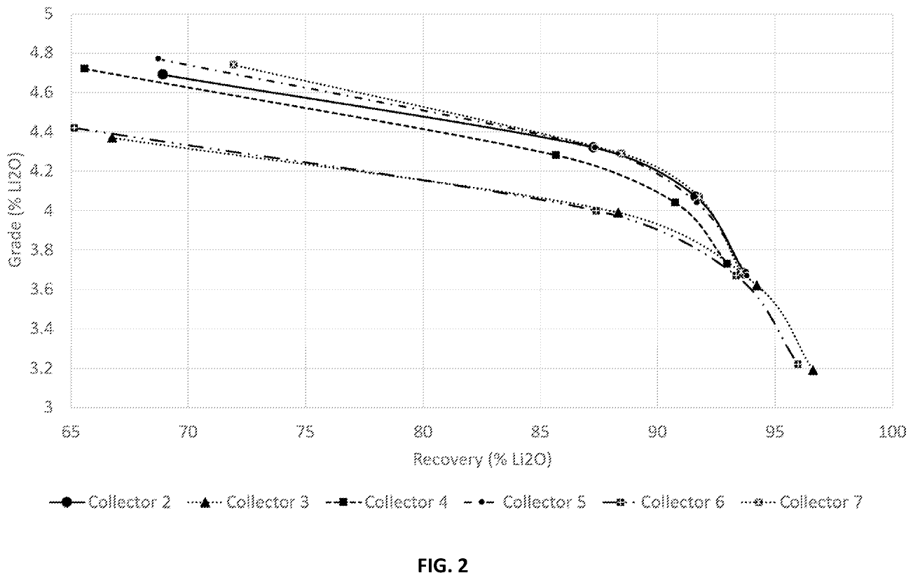

Grade % of lithium as Li₂O, that is, purity of the collected froth product in the Flotation Test, was determined as a function of percent Li₂O recovered from the ore. A plot showing grade % of lithium as Li₂O as a function of percent Li₂O recovered for Collectors 2-7 is shown in FIG. 2. Table 3 shows grade and % recovery of Li₂O for concentrates Con 1-Con 4, as collected for Collectors 2-7 in the Flotation Test Procedure. Collectors 3 and 6 were not as selective as Collectors 2, 4, 5, and 7, which provided higher yield of selected grade % of lithium as Li₂O.

TABLE 3
Grade and % recovery of lithium as Li₂O for
concentrates Con 1-Con 4 of Example 3.

| | | Con 1 | Con 2 | Con 3 | Con 4 |
|---|---|---|---|---|---|
| Collector 2 | Grade, % Li₂O | 4.69 | 4.32 | 4.07 | 3.68 |
| | Recovery, % | 68.92 | 87.25 | 91.62 | 93.71 |
| Collector 3 | Grade, % Li₂O | 4.37 | 3.99 | 3.62 | 3.19 |
| | Recovery, % | 66.75 | 88.32 | 94.23 | 96.62 |
| Collector 4 | Grade, % Li₂O | 4.72 | 4.28 | 4.04 | 3.73 |
| | Recovery, % | 65.58 | 85.69 | 90.75 | 92.97 |
| Collector 5 | Grade, % Li₂O | 4.77 | 4.32 | 4.04 | 3.67 |
| | Recovery, % | 68.72 | 87.32 | 91.67 | 93.81 |
| Collector 6 | Grade, % Li₂O | 4.42 | 4.00 | 3.67 | 3.22 |
| | Recovery, % | 65.14 | 87.38 | 93.34 | 95.97 |
| Collector 7 | Grade, % Li₂O | 4.74 | 4.29 | 4.07 | 3.69 |
| | Recovery, % | 71.93 | 88.45 | 91.77 | 93.55 |

What is claimed is:

1. A froth flotation collector composition comprising
a hydroxycarboxylic acid, a conjugate base thereof, or a mixture thereof,
a solvent, and
a surfactant comprising:
(a) a compound having the formula XOOC—CH(R)—CH₂—COOY, wherein R is a substituent selected from C10-C22 alkyl, alkenyl, aryl, aralkyl, or aralkenyl, and X and Y are independently selected from hydrogen, lithium, sodium, potassium, calcium, zinc, magnesium, ammonium, alkylammonium, and alkanolammonium;
(b) an ethoxylated sorbitan fatty acid ester comprising an alkyl or alkenyl group having 18 carbons; or
(c) a combination of one or more (a) and one or more (b).

2. The froth flotation collector composition of claim 1 wherein the hydroxycarboxylic acid is ricinoleic acid.

3. The froth flotation collector composition of claim 1 wherein the ratio of the hydroxycarboxylic acid to the surfactant is 5:1 to 1:5 by weight.

4. The froth flotation collector composition of claim 1 wherein the solvent comprises one or more of: methanol, ethanol, isopropanol, n-propanol, n-butanol, isobutanol, ethylene glycol, propylene glycol, 2-methoxyethanol, 2-butoxyethanol, diethylene glycol, 2-(2-methoxyethoxy)ethanol, bis(2-methoxyethyl) ether, triethylene glycol, glycerol, ethyl acetate, acetone, methyl ethyl ketone, and triacetin.

5. A lithium beneficiation slurry comprising
a lithium ore source;
a water source;
a hydroxycarboxylic acid and/or a conjugate base thereof;
a surfactant; and
a solvent.

6. The lithium beneficiation slurry of claim 5 wherein the lithium beneficiation slurry excludes or substantially excludes oleic acid or a conjugate base thereof.

7. The lithium beneficiation slurry of claim 5 consisting essentially of the lithium ore source, the water source, the hydroxycarboxylic acid or conjugate base thereof, the surfactant, and the solvent.

8. The lithium beneficiation slurry of claim 5 wherein the surfactant is an anionic surfactant, a nonionic surfactant, or a mixture thereof.

9. The lithium beneficiation slurry of claim 5 wherein the surfactant comprises a mixture of a dianionic surfactant and a nonionic surfactant.

10. The lithium beneficiation slurry of claim 5 wherein the surfactant comprises a dianionic surfactant having the structure XOOC—CH(R)—CH₂—COOY, wherein R is a substituent selected from C10-C22 alkyl, alkenyl, aryl, aralkyl, or aralkenyl, and X and Y are independently selected from hydrogen, lithium, sodium, potassium, calcium, zinc, magnesium, ammonium, alkylammonium, and alkanolammonium.

11. The lithium beneficiation slurry of claim 10 wherein R is an alkyl or alkenyl group having 18 carbons.

12. The lithium beneficiation slurry of claim 5 wherein the surfactant comprises a sulfonated surfactant.

13. The lithium beneficiation slurry of claim 5 wherein the surfactant comprises an ethoxylated sorbitan fatty acid ester.

14. The lithium beneficiation slurry of claim 13 wherein the ethoxylated sorbitan fatty acid ester comprises an alkyl or alkenyl group having 18 carbons.

15. The lithium beneficiation slurry of claim 5 wherein the hydroxycarboxylic acid or conjugate base thereof is ricinoleic acid or a conjugate base thereof.

16. The lithium beneficiation slurry of claim 5 wherein the lithium ore comprises a spodumene.

17. The lithium beneficiation slurry of claim 5 wherein the lithium ore source is a comminuted lithium ore source, a classified lithium ore source, or a comminuted classified lithium ore source.

18. A method of lithium ore froth flotation, the method comprising combining a lithium ore source, a water source, and a collector composition to form a lithium beneficiation slurry, wherein the collector composition comprises a hydroxycarboxylic acid and/or a conjugate base thereof, a surfactant, and a solvent;
sparging the lithium beneficiation slurry to form a froth; and
collecting the froth.

19. The method of claim 18 further comprising comminuting the lithium ore source, classifying the lithium ore source, or both comminuting and classifying the lithium ore source prior to the combining.

20. The method of claim 18 wherein the hydroxycarboxylic acid is ricinoleic acid, further wherein the lithium beneficiation slurry excludes an oleic acid and/or a conjugate base thereof.
